(19) United States
(12) Patent Application Publication
(10) Pub. No.: US 2004/0094617 A1
(43) Pub. Date: May 20, 2004

(54) Concept to invent software technology that will produce a hidden photo personal information and credit card number that can be installed in a credit card

(76) Inventor: Obra Hogans SR., Lithonia, GA (US)

Correspondence Address: Obra Hogans, Sr., Suite N., 4303 Memorial Dr., Decatur, GA, 30032, US

(21) Appl. No.: 10/036,884

(22) Filed: Jun. 20, 2002

(51) Int. Cl. G06K 5/00

(52) U.S. Cl. 235/380

(57) ABSTRACT

My intended invention is similar to a standard credit card by look; it is a thin plastic card with an appearance of a major credit card on the front side, accept the account number, and with a white back which contains a black strip and general credit card information regarding the customer service number and address. It has a dimension of 2′×3.25″. The card holder photo will be concealed inside the card, which no one will see until the card has been scanned and the photo will then appear. The credit card number is also concealed on the front cover. This card cannot be duplicated!

### DESCRIPTION/SPECS

My intended invention is similar to a standard credit card by look; it is a thin plastic card with an appearance of a major credit card on the front side, accept the account number, and with a white back which contains a black strip and general credit card information regarding the customer service number and address.

It has a dimension of 2″×3.25″. The card holder photo will be concealed inside the card, which no one will see until the card has been scanned and the photo will then appear. The credit card number is also concealed on the front cover. This card cannot be duplicated!

1. I claim my invention will help protect the mass number of credit card fraudulent activities by disclosing a hidden picture which appears as it is scanned.
